(19) United States
(12) Patent Application Publication
(10) Pub. No.: US 2023/0070672 A1
(43) Pub. Date: Mar. 9, 2023

(54) ROUTING AND SCHEDULING IN ROBOTIC AND VEHICULAR SYSTEMS BASED ON FAMILY COLUMN GENERATION

(71) Applicant: Next Generation Robotics, Inc., New York, NY (US)

(72) Inventors: Julian Yarkony, La Jolla, CA (US); David Pepper, New York, NY (US); Amelia Regan, Irvine, CA (US)

(21) Appl. No.: 17/656,868

(22) Filed: Mar. 28, 2022

Related U.S. Application Data
(60) Provisional application No. 63/235,074, filed on Aug. 19, 2021.

(51) Int. Cl. G06Q 10/08; G05B 17/02; G06Q 10/04

(52) U.S. Cl. CPC G06Q 10/087; G05B 17/02; G06Q 10/04

(57) ABSTRACT

Disclosed are devices, systems and methods for routing and scheduling based on family column generation (FCG). The described embodiments provide a dual stabilization method that accelerates column generation (CG), thereby decreasing the number of iterations of CG needed to solve the problem. An example method includes receiving information associated with each of the plurality of facilities, receiving a plurality of demands associated with each of the plurality of customers, generating, based on the information and the plurality of demands, a facility location problem, splitting the facility location problem into a master problem and a subproblem, and iteratively solving, using a FCG method, the master problem and the subproblem to generate the solution comprising assignments between the plurality of customers and the subset of the plurality of facilities that minimize the total cost.

### CROSS-REFERENCE TO RELATED APPLICATION

This present document claims priority to and benefits of U.S. Provisional Application 63/235,074 filed on Aug. 19, 2021. The entire contents of the aforementioned patent applications are incorporated by reference as part of the disclosure of this patent document.

### TECHNICAL FIELD

The present document generally relates to robotic and vehicular systems, and more specifically, to routing and scheduling in these systems using family column generation.

### BACKGROUND

Linear programming (LP, also called linear optimization) is a method to achieve the best outcome (such as maximum profit or lowest cost) in a mathematical model whose requirements are represented by linear relationships. Linear programming can be applied to various fields of study and various industries. Industries that use linear programming models include transportation, energy, telecommunications, and manufacturing. It has proven useful in modeling diverse types of problems in planning, routing, scheduling, assignment, and design.

### SUMMARY

In various applications, associated linear programs may be too large to consider all the variables explicitly. However, it is often the case that most of the variables will be non-basic and assume a value of zero in the optimal solution. Because of this, only a subset of variables need to be considered in theory when solving the problem. Column generation leverages this idea to generate only the variables which have the potential to improve the objective function—that is, to find variables with negative reduced cost (assuming without loss of generality that the problem is a minimization problem).

Embodiments of the disclosed technology provide a dual stabilization method that accelerates column generation, thereby decreasing the number of iterations of column generation needed to solve the problem. The dual stabilization method described herein is referred to as family column generation (FCG)

In an example aspect, a method of solving a facility location problem is disclosed. This method includes receiving information associated with each of the plurality of facilities, wherein the information comprises an opening cost and a capacity for the corresponding facility, receiving a plurality of demands associated with each of the plurality of customers, generating, based on the information and the plurality of demands, a facility location problem, wherein a solution to the facility location problem minimizes a total cost of opening a subset of the plurality of facilities such that (a) each of plurality of customers is assigned to exactly one of the subset of the plurality of facilities and (b) the demand for a particular customer is less than the capacity of the assigned facility, and wherein the total cost comprises the opening cost for each of subset of the plurality of facilities and a cost associated with assigning the particular customer to the corresponding facility, splitting the facility location problem into a master problem and a subproblem, wherein the master problem and the subproblem comprise constraints associated with the facility location problem, and iteratively solving, using a family column generation method, the master problem and the subproblem to generate the solution comprising assignments between the plurality of customers and the subset of the plurality of facilities that minimize the total cost, wherein the family column generation method comprises a column generation method, wherein the column generation method comprises adding a column to the master problem as part of solving the subproblem, wherein the column corresponds to an assignment of a candidate customer to a candidate facility, wherein the family column generation method further comprises adding a family of the column to the master problem as part of solving the subproblem, and wherein the family of the column corresponds to assignments of additional candidate customers to the candidate facility such that a demand of each of the additional candidate customers is less than the capacity of the candidate facility.

In another example aspect, a method of solving a vehicle routing problem is disclosed. This method includes receiving information associated with a depot location and different items at item locations, wherein the information for each of the items comprises an item location and an integer demand indicating a size of the item, generating, based on the depot location, the integer demand and the item location of each of the items, and the plurality of vehicles, a vehicle routing problem, wherein a solution to the vehicle routing problem minimizes a sum of a distance of each route of a plurality of routes, wherein each route of a plurality of routes for each of the plurality of vehicles (a) starts and ends at the depot location, (b) visits an item location no more than once, and (c) services a capacity that does not exceed each vehicle's capacity to carry items, splitting the vehicle routing problem into a master problem and a subproblem, wherein the master problem and the subproblem comprise constraints associated with the vehicle routing problem, iteratively solving, using a family column generation method, the master problem and the subproblem to generate the solution comprising a plurality of optimized routes that minimize the sum of the distance of each route of the plurality of routes, and transmitting, to each of the plurality of vehicles, a corresponding optimized route of the plurality of optimized routes, wherein the family column generation method comprises a column generation method, wherein the column generation method comprises adding a column to the master problem as part of solving the subproblem, wherein the column corresponds to a particular route with an ordering of items serviced by a particular vehicle on the particular route, wherein the family column generation method further comprises adding a family of the column to the master problem as part of solving the subproblem, and wherein the family of the column corresponds to one or more routes that maintain the ordering of the items with one or more items removed from each column in the family of the column.

In yet another example aspect, a distributed computing system that implements the above-described methods is disclosed.

In yet another example aspect, the methods may be embodied as processor-executable code and may be stored on a computer-readable program medium.

These, and other, features are described in this document.

### BRIEF DESCRIPTION OF THE DRAWINGS

Drawings described herein are used to provide a further understanding and constitute a part of this application. Example embodiments and illustrations thereof are used to explain the technology rather than limiting its scope.

FIGS. 1A and 1B show different example representations of implementing a column generation (CG) algorithm.

FIG. 2 shows the pseudocode for an example of determining optimal travel distance when implementing the family column generation (FCG) algorithm.

FIG. 3 shows the pseudocode for an example FCG algorithm.

FIG. 4 shows the pseudocode for an example of solving the family restricted MP.

FIGS. 5A and 5B show example aggregate results as a function of iteration count.

FIGS. 6A and 6B show example aggregate results as a function of total runtime.

FIGS. 7A and 7B show example aggregate results as a function of total LP time.

FIG. 8 shows an example of a warehouse with robots that are routed or scheduled according to embodiments of the presently disclosed technology.

FIGS. 9 and 10 show flowcharts of example methods according to embodiments of the presently disclosed technology.

FIG. 11 is a block diagram representation of a portion of an apparatus that can be configured to implement some embodiments of the presently disclosed technology.

### DETAILED DESCRIPTION

To make the purposes, technical solutions and advantages of this disclosure more apparent, various embodiments are described in detail below with reference to the drawings. Unless otherwise noted, embodiments and features in embodiments of the present document may be combined with each other.

Section headings are used in the present document, including the appendices, to improve readability of the description and do not in any way limit the discussion to the respective sections only.

### 1 Introduction

Column generation is a widely used tool in computational optimization as a way to solve huge mixed integer problems. One of the main advantages of column generation is that not all possible solutions of the problem need to be enumerated. Instead, the problem being solved is split into two problems: the master problem and the sub-problem. The master problem is the original column-wise formulation of the problem with only a subset of variables being considered (and is also referred to as the restricted master problem (RMP)). The sub-problem is a new problem created to identify a new promising variable. The objective function of the sub-problem is the reduced cost of the new variable with respect to the current dual variables, and the constraints require that the variable obeys the naturally occurring constraints.

When the master problem is solved, dual prices can be obtained for each of the constraints in the master problem. This information is then utilized in the objective function of the subproblem. The subproblem is solved. If the objective value of the subproblem solution is negative, a variable with negative reduced cost has been identified. This variable is then added to the master problem, and the master problem is re-solved. Re-solving the master problem will generate a new set of dual values, and the process is repeated until no negative reduced cost variables are identified. The subproblem returns a solution with non-negative reduced cost, it can be concluded that the solution to the master problem is optimal.

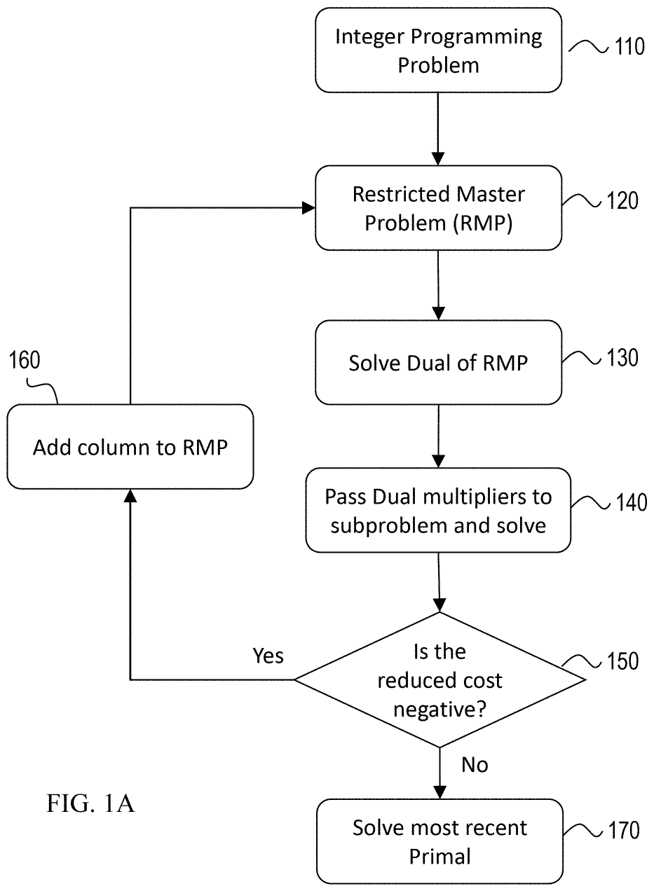

FIGS. 1A and 1B show different representations of an example column generation algorithm. As shown therein, the integer program is first formulated (step 110) and used to generate the restricted master problem (RMP) (step 120). The dual of the RMP is solved (step 130), and the dual multipliers are passed to the subproblem to be solved (step 140). The algorithm checks whether any of the reduced costs are negative (step 150); if yes, the column is added to the RMP (step 160), and if not, the most recent primal solution is solved (step 170).

In other words, during the column generation process, the dual variables (i.e., multipliers) are used to price out the non-basic variables (i.e., columns) by considering their reduced costs. The dual variables ensure that the reduced cost for every variable in the basis is zero. If any reduced cost is of the wrong sign in the master problem, the process will introduce the corresponding non-basic variable into the basis in place of one of the current basic variables, and recompute the simplex multipliers (i.e., dual variables).

1.1 Overview of Column Generation

The basic column generation (CG) problem is discussed in this section in the context of the broad class of set cover problems. Herein, for the facility location problem (discussed in section 1.3), N is used to denote the set of items to be covered, which is indexed by u; F is used to denote the set of facilities, which is index by f. The set of feasible pairs between a subset of N and a single member f is denoted using Ω, and which is described using αᵤₗ∈{0,1} and b_{fl}∈{0,1}. Here, αᵤₗ=1 if and only if (IFF) l includes item u and otherwise aᵤₗ=0. Similarly, b_{fl}=1 IFF l uses facility f and otherwise b_{fl}=0. Each l∈Ω is associated with a cost cₗ. Set cover is framed as the following set cover integer linear program (ILP), which enforces that each facility is used no more than once. Here, θₗ∈{0,1} is a binary variable used to describe the solution to set cover, and θₗ=1 IFF l is included in the solution and otherwise is zero.

$${min}_{{θ}_{\text{?}} ∈ \{ 0 , 1 \}} {\sum }_{l ∈ Ω} {c}_{l} {θ}_{l} \qquad ( 1 a )$$

$$\begin{matrix}{\sum }_{l ∈ Ω} {a}_{ul} {θ}_{l} \geq 1 & ∀ u ∈ N\end{matrix} \qquad ( 1 b )$$

$$\begin{matrix}{\sum }_{l ∈ Ω} {b}_{\text{?}} {θ}_{l} \leq 1 & ∀ f ∈ F\end{matrix} \qquad ( 1 c )$$

$$\text{?} \text{indicates text missing or illegible when filed}$$

For the above equations, the total cost of columns in Ω that were selected is minimized in (1a). (1b) enforces that each item is included in at least one column. In most applications (1b) is tight for all u∈N in any optimal solution. (1c) enforces that no facility is used more than once. In some embodiments, the total number of columns selected not exceeding a particular value can be enforced, e.g., by offsetting cₗ by a constant for all l to encourage (or discourage) the use of more columns. The above formulation includes the single source capacitated facility location problem (SSCFLP) and the vehicle routing problem (VRP).

Solving (1) is NP-hard; however efficient exact or approximate algorithms can be built using the column generation (CG) framework. CG solves the LP relaxation of (1), which is well approximated in many applications.

In CG, a sufficient subset of Ω, denoted Ω_{R}, is generated to provably solve optimization over all Ω. This is done by iteratively solving the LP over Ω_{R} and adding columns with negative reduced cost to the nascent set of columns Ω_{R}. CG terminates when no column in Ω_{R} has negative reduced cost. The primal and dual LP relaxations over Ω_{R}, with dual variables denoted in [ ] by their associated constraints, as shown below:

$$Primal Optimization : {min}_{θ \geq 0} {\sum }_{l ∈ {Ω}_{R}} {c}_{l} {θ}_{l} \qquad ( 2 a )$$

$$\begin{matrix}{\sum }_{l ∈ {Ω}_{R}} {a}_{ul} {θ}_{l} \geq 1 & ∀ u ∈ N & [ {π}_{u} ]\end{matrix} \qquad ( 2 b )$$

$$\begin{matrix}{\sum }_{l ∈ {Ω}_{R}} {b}_{fl} {θ}_{l} \leq 1 & ∀ f ∈ F & [ - {π}_{f} ]\end{matrix} \qquad ( 2 c )$$

$$Dual Optimization : {max}_{π \geq 0} {\sum }_{u ∈ N} {π}_{u} - {\sum }_{f ∈ F} {π}_{f} \qquad ( 3 a )$$

$$\begin{matrix}{c}_{l} + {\sum }_{f ∈ F} {b}_{fl} {π}_{f} - {\sum }_{l ∈ Ω} {a}_{ul} {π}_{u} \geq 0 & ∀ l ∈ {Ω}_{R} , [ {θ}_{l} ]\end{matrix} \qquad ( 3 b )$$

CG optimization is initialized with columns in Ω_{R} that describe a feasible solution to (2). This is followed by CG iterating between the following two steps until no column has a negative reduced cost.

Step 1. Solve (2) providing a primal and a dual solution

Step 2. Find the lowest reduced cost column associated with each facility f∈F, and add the negative reduced cost columns identified to Ω_{R}. This step is referring to as pricing.

CG terminates when pricing fails to identify a negative reduced cost column. The corresponding primal solution θ is provably optimal for optimization over Ω at the termination of CG. In an example, pricing is written below for a given fixed facility f, with Ω_{f} used to denote the subset of columns associated with f and c̅ₗ used to denote the reduced cost of column l.

$${min}_{l ∈ {Ω}_{f}} {\overline{c}}_{l} \qquad ( 4 a )$$

$${\overline{c}}_{l} = {c}_{l} + {π}_{f} - {\sum }_{u ∈ N} {a}_{\text{?}} {π}_{\text{?}} \qquad ( 4 b )$$

$$\text{?} \text{indicates text missing or illegible when filed}$$

Solving pricing is typically a combinatorial optimization problem, and is typically problem-domain specific. Most commonly it is solved as a dynamic program or resource constrained shortest path problem, although in some cases, it can be a small-scale ILP. The solution at termination of optimization may still be fractional. Multiple mechanisms can be used to tackle this issue while achieving exact optimization. The set cover LP relaxation can be further tightened in a cutting plane manner by valid inequalities such as subset-row inequalities. The use of such valid inequalities permits optimization with CG. CG can be built into an exact branch-bound search procedure using branch-price.

1.2 Examples of Lagrangian Relaxation

In some embodiments, the Lagrangian function is smooth and concave, and has a value identical to that of the master problem (MP) at the optimizing dual solution for the MP. The value of the Lagrangian function evaluated at given dual solution is referred to as the Lagrangian bound. At any given point in CG optimization a lower bound on the optimal solution can be generated, which is referred to as the Lagrangian bound. The Lagrangian bound can be used to provide as stopping criteria for CG (e.g., for early termination). In an example, when the difference between the objective of the RMP solution and the Lagrangian bound is sufficiently small (according to a user-defined criteria), the CG optimization may be terminated.

Given a dual solution it, the Lagrangian bound at the dual solution is denoted l_{π} and can be defined as:

$$MP \geq {ℓ}_{π} = {\sum }_{u ∈ N} {π}_{u} - {\sum }_{f ∈ F} {π}_{f} + {\sum }_{f ∈ F} min ( 0 , {min}_{l ∈ {Ω}_{f}} {\overline{c}}_{l} ) \qquad ( 5 a )$$

It is noted that pricing provides min_{l∈Q}_{_{f}}c̅ₗ at each iteration of CG, and thus evaluating the Lagrangian bound incurs no additional computational difficulty. Furthermore, any non-negative solution π can be projected to one that is a feasible solution to the dual master problem ((3) with Ω_{R}←Ω) with an objective identical to the Lagrangian bound in (5a) by setting π_{f}←π_{f}+min (0, min_{l∈Ω}_{_{f}}c̅ₗ).

1.3 The Facility Location Problem (FLP)

In an example, the described FCG embodiments are developed in the context of the single source capacitated facility location problem (SSCFLP). Herein, a set of customers N and a set of potential facilities F are provided such that F∩N=Ø. Each facility f E F is associated with a fixed opening cost c_{f} and a capacity K_{f}. Each customer u∈N is associated with a demand dᵤ≥0. Each pair (f, u)∈F×N is associated with an assignment cost c_{fu}≥0. Without loss of generality, it is assumed that all parameters are integer-valued. The SSCFLP requires selecting a subset of facilities to open and assigning every customer to exactly one open facility in such a way that the capacities of the selected facilities are respected, and a minimum total cost (fixed costs+assignment costs) is achieved.

The pricing subproblem is a 0-1 knapsack problem, and can be conditioned on facility f and written as:

$${min}_{\begin{matrix}\text{?} ∈ \{ 0 , 1 \} & ∀ u ∈ N\end{matrix}} {c}_{f} + {π}_{f} + {\sum }_{u ∈ N} \text{?} ( {c}_{{f}_{u}} - {π}_{u} ) \qquad ( 6 a )$$

$${\sum }_{u ∈ N} \text{?} {d}_{u} \leq {K}_{f} \qquad ( 6 b )$$

$$\text{?} \text{indicates text missing or illegible when filed}$$

Herein, xᵤ∈{0,1} denotes the decision variable for customer u, wherein xᵤ=1 IFF customer u is included.

### 2 Example Embodiments of Family Column Generation (FCG)

Embodiments of the disclosed technology are directed to the family column generation (FCG) algorithm, which differs from CG (see section 1.1) inter alia in the mechanism to generate dual solutions, upon which pricing is performed. FCG (approximately) solves the Family Restricted Master Problem (FRMP) at each iteration of CG, and advantageously better approximates the MP at each iteration of CG than the standard RMP, while preserving efficient inference. The FRMP describes the LP over the set of all columns that lie in the family of any member of l∈Ω_{R}, which is denoted Ω_{R}⁺ and defined as Ω_{R}⁺=∪_{l∈Ω}_{_{R}}∪_{l∈Ω}_{_{\hat{l}}}l, where Ω_{\hat{l}} refers to the family of \hat{l}. Ω_{\hat{l}} is defined to be a subset of Ω_{f}_{_{\hat{l}}} (with f_{\hat{l}} being the facility associated with column l) including l over which pricing can be easily performed, but ideally of combinatorial size and ideally containing many columns “similar” to l.

In the case of the SSCFLP, \hat{l} is a column that is associated with facility f and items N_{\hat{l}}. The set Ω_{\hat{l}} is the set of columns each associated with facility f, and a customer set that lies in the power set N_{\hat{l}}. An alternative description of Ω_{\hat{l}} is the set of columns in Ω_{f}_{_{\hat{l}}} associated with the facility f and which contains no more than l_{d}=(Σ_{u∈N}αᵤₗ[dᵤ≥d]) items of size greater than d for any size d∈ [symbol] ₀₊. In some examples, this family is larger than the previous family, but is more difficult (though still easy) to price over.

In the case of the capacitated vehicle routing problem (CVRP), Ω_{\hat{l}} contains the set of columns in which the order of customers visited is the same as l but a subset (perhaps empty) of those customers are removed.

In some embodiments, the solution to FRMP optimization is attacked with a coordinate ascent method in the dual. In this method, a direction of travel is generated, and then an optimal amount is traveled in that direction. This is repeated until it is no longer possible to improve the FRMP objective. FCG terminates only when FRMP is solved exactly and no column has negative reduced cost, certifying that the solution is optimal for the MP.

2.1 Example Methods of Generating the Direction of Travel

In some embodiments, directions can be generated to improve an incumbent dual solution, denoted π⁰. This solution is based on creating an approximation to the dual FRMP around the best solution in terms of Lagrangian bound identified thus far, π⁰, where ν describes the size of the window over which the approximation is constructed. The value of ν trades off the size of the space the approximation is done over and the quality of the approximation. An upper bound on the MP can then be optimized over this local approximation, thereby providing a solution π̅. Finally, travel from π⁰ in the direction of \vec{π} where \vec{π}←π̅−π⁰.

Herein, the set Ω_{Rπ} is constructed to provide a good approximation to solve the FRMP. In some embodiments, the constructions of Ω_{Rπ} must not use expensive operations such as calls to non-trivial pricing problems, or calls to an LP solver, and must not result in an explosion in the number of columns. The construction described herein is motivated by the following equivalent way of writing the optimization over Ω_{R}⁺ over the window defined by (the best solution in terms of Lagrangian bound identified thus far) π⁺, π⁻, and shown below as:

$${max}_{π \geq 0} {\sum }_{u ∈ N} {π}_{u} - {\sum }_{f ∈ F} {π}_{f} \qquad ( 9 a )$$

$$\begin{matrix}{min}_{l ∈ {Ω}_{l}} {c}_{l} + {\sum }_{f ∈ F} {b}_{fl} {π}_{f} - {\sum }_{u ∈ N} {a}_{\text{?}} {π}_{u} \geq 0 & ∀ \ddot{l} ∈ {Ω}_{R}\end{matrix} \qquad ( 9 b )$$

$$\begin{matrix}{π}_{u}^{+} \geq {π}_{u} \geq {π}_{u}^{-} & ∀\end{matrix} u ∈ N \qquad ( 9 c )$$

$$\text{?} \text{indicates text missing or illegible when filed}$$

In some cases, the optimization over (9) may be intractable but can be efficiently approximated using the following upper bound. The πᵤ terms in (9b) can be replaced with if πᵤ⁺ for u∈N_{\hat{l}} and max (0, πᵤ⁻) for u∈N−N_{\hat{l}}. Thus, there is only one constraint for each l∈Ω_{R} (e.g., column generated during pricing), and in the applications described in this document, no expensive calls to NP-hard pricing oracles are required. Using (9b), Ω_{Rπ} can be defined as:

$${Ω}_{{R}_{π}} = {⋃}_{l ∈ {Ω}_{R}} {\ddot{l}}_{π} \qquad ( 10 a )$$

$${\ddot{l}}_{π} = arg {min}_{l ∈ {Ω}_{l}} {c}_{l} + {\sum }_{f ∈ F} {b}_{fl} {π}_{f} - {\sum }_{u ∈ {N}_{i}} {a}_{ul} {π}_{u}^{+} {- \sum }_{u ∈ N - {N}_{i}} {a}_{ul} {π}_{u}^{-} \qquad ( 10 b )$$

In this section, the described embodiments include mechanisms to produce directions of travel that locally approximate the FRMP over the area around an incumbent solution π⁰.

2.2 Example Methods of Determining the Optimal Travel Distance

In some embodiments, the optimal distance to travel along the ray starting at π⁰ and traveling in direction \vec{π} (where the ray is denoted (π⁰, \vec{π})) can be determined so as to approximately maximize the Lagrangian bound (as written in (5a)). Since evaluating the Lagrangian bound requires a call to pricing, which may be expensive, a concave approximation to (5a) can be used such that the Lagrangian bound is equal to the MP at an optimizing π (for the MP). This bound, denoted l_{π}^{Q}^{_{R}}^{⁺}, considers only columns in Ω_{R}⁺ and uses (10b), which is easy to compute. lₙ^{Ω}^{_{R}}^{⁺} can be defined using helper term l_{π}^{\hat{l}}, which is the reduced cost of the lowest reduced cost column in the family of \hat{l}.

$${ℓ}_{π} \leq {ℓ}_{π}^{{Ω}_{R}^{+}} = {\sum }_{u ∈ N} {π}_{u} - {\sum }_{f ∈ F} {π}_{f} + {\sum }_{f ∈ F} {min}_{i ∈ {Ω}_{R} ⋂ {Ω}_{f}} min ( 0 , {ℓ}_{π}^{\text{?}} ) \qquad ( 14 a )$$

$${ℓ}_{\text{?}}^{\text{?}} = {min}_{l ∈ {Ω}_{\text{?}}} {\overline{c}}_{l} \qquad ( 14 b )$$

$$\text{?} \text{indicates text missing or illegible when filed}$$

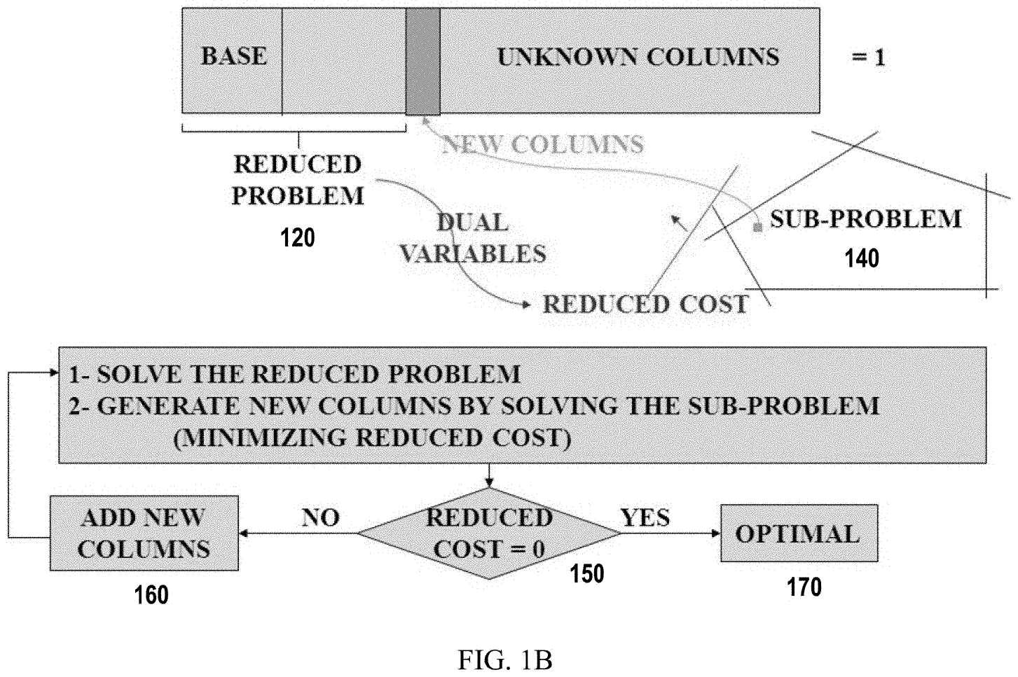

In some embodiments, the optimal distance to travel is η*∈[0,1] and can be described using the algorithm shown in FIG. 2, which implements a binary search style procedure to determine the optimal distance to travel within a user-defined tolerance.

2.3 Example Algorithms for FCG

Embodiments of the disclosed technology include the family column generation (FCG) algorithm, wherein, at each iteration of the FCG, the FRMP is solved approximately and then followed by pricing. In some embodiments, the FCG is parameterized by one parameter: the step size ν. In other embodiments, the solution of the FRMP is found using the coordinate ascent approach of alternating between generating directions and going the optimal amount in that direction as measured by an approximation to the Lagrangian bound. The FRMP optimization is terminated when the current solution π satisfies one of the following:

(1) π describes the optimal solution to the RMP over Ω_{R}⁺, or

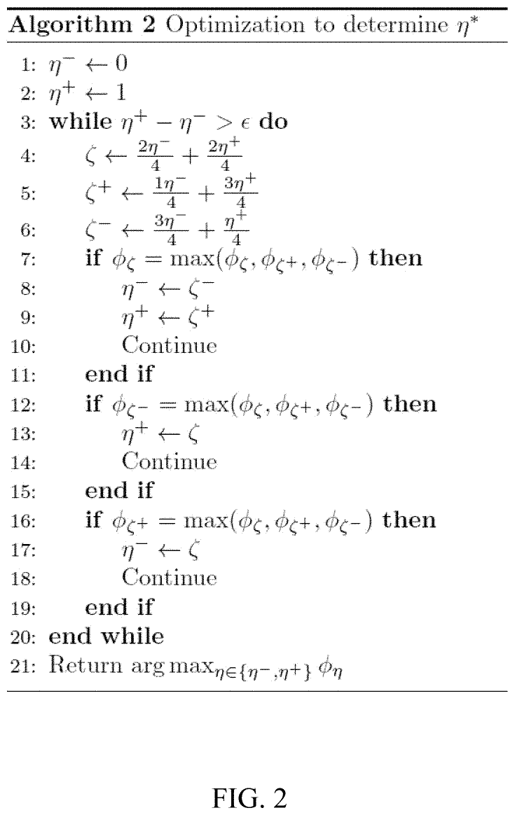

(2) If the optimal distance to travel does not equal or exceed the minimum amount 1/m. Convergence of the FCG is ensured when at least 1/m times the maximum possible distance is traveled. The pseudocode for an example FCG algorithm (denoted Algorithm 4) is shown in FIG. 3, where:

Line 1: The input Ω_{R} is received and provides for a feasible though not optimal solution for the MP. In addition, the step size ν and initial π* are received, the latter of which can be set trivially to the RMP solution over Ω_{R} or any other mechanism, e.g., the zero vector.

Lines 2-13: Solve the MP over Ω. The optimization problem is solved by terminating when no column has negative reduced cost. In some embodiments, termination can only happen if the FRMP is solved optimally.

Line 3: Receive approximate solution to FRMP over Ω_{R}.

Lines 4-9: Compute the lowest reduced cost column associated with each f∈F, and then add any negative reduced cost columns computed to Ω_{R}.

Lines 10-12: Store the best solution found so far. In some embodiments, the best solution is defined as the solution that maximizes the Lagrangian bound.

Line 14: Return the last solution generated θ, which is provably optimal and feasible for the master problem (MP).

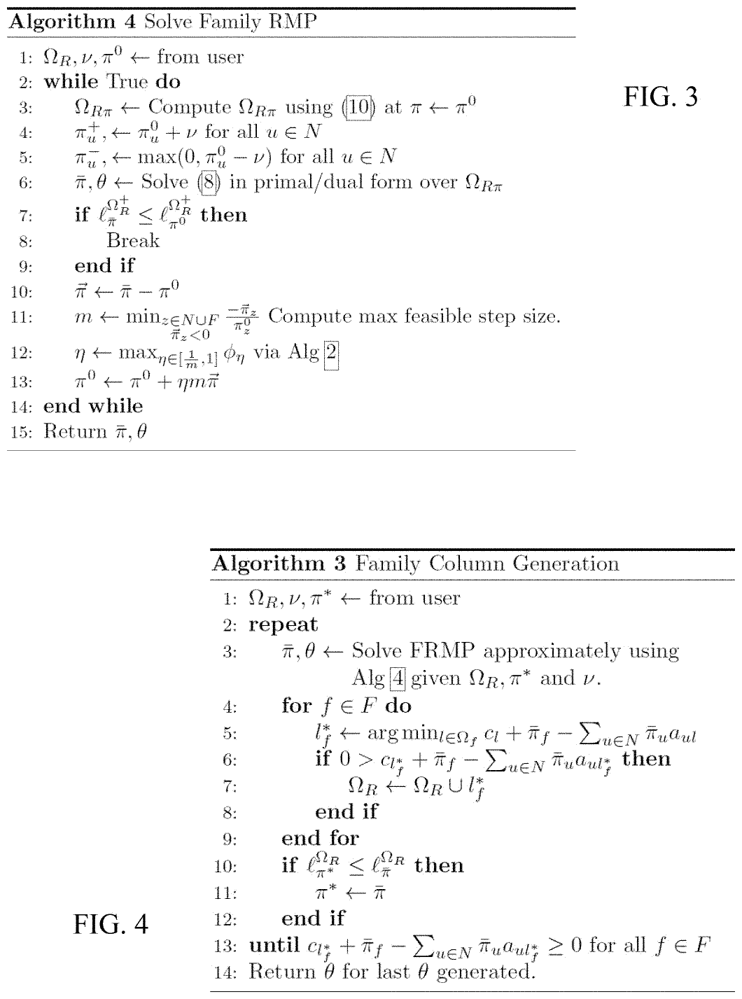

In the pseudocode shown in FIG. 3, Line 3 solves the approximate solution to the FRMP, which is further detailed in the pseudocode (denoted Algorithm 3) shown in FIG. 4. Herein:

Line 1: Receive input feasible solution, step size and initial solution π⁰

Lines 2-14: Solve the FRMP approximately using coordinate ascent. Terminate when either FRMP is optimally solved or there exists an l∈Ω_{R}⁺−Ω_{R} with negative reduced cost, which implies that the updated step did not improve the Lagrangian bound over Ω_{R}.

Line 3: Use (10) to construct Ω_{Rπ} evaluated at π←π⁰.

Lines 4-5: Determine π⁺, π⁻ terms

Line 9: Solve (8) providing optimal primal/dual solution pair over the box described by π⁺, π⁻

Lines 7-9: If l_{π̅}^{Ω}^{_{R}}^{⁺} is associated with inferior approximate Lagrangian bound relative to l_{π}_{⁰}^{Ω}^{_{R}}^{⁺}, break execution and return π̅. The ensures that a new column is generated very close to the current incumbent dual maximizing solution.

Line 11: Compute maximum feasible step size as described by (15). If no components appear under the min then this is unbounded, and use a large positive number. Compute the point \hat{π} corresponding to traveling the maximum possible distance in the vector corresponding to starting at π⁰ and traveling towards π.

Line 12: Compute the optimal travel distance using the pseudocode shown in FIG. 2. Note that the search only needs to be performed in the range

$$η ∈ [ \frac{1}{m} , 1 ]$$

because the minimum step size is 1/m.

Line 13: Update π⁰ to be optimal dual solution produced during the execution of the pseudocode shown in FIG. 2.

Line 15: Return approximate solution to FRMP.

2.4 Example Methods for Column Projection

In some embodiments, column projection can be used to solve (10b) in Algorithm 4 (the pseudocode shown in FIG. 3). In the context of SSCFLP, Ω_{\hat{l}} is defined to contain the set of columns associated with facility f_{\hat{l}} and contain a subset of the customers in Nₗ, and is represented as:

Ω_{\hat{l}}=(l∈Ω; Nₗ⊆Nᵢ; fₗ=fᵢ) (16)

Using the definition in (16), (10b) for SSCFLP can be written as:

$${min}_{\begin{matrix}\text{?} ∈ \{ 0 , 1 \} & ∀ u ∈ N\end{matrix}} {c}_{f} + {π}_{f} + {\sum }_{u ∈ N} \text{?} ( {c}_{{f}_{u}} - {π}_{u} ) \qquad ( 17 a )$$

$${\sum }_{u ∈ N} \text{?} {d}_{u} \leq {K}_{f} \qquad ( 17 b )$$

$$\text{?} \begin{matrix}= 0 & ∀ u ∉\end{matrix} {N}_{l} \qquad ( 17 c )$$

$$\text{?} \text{indicates text missing or illegible when filed}$$

Any binary valued solution satisfying (17c) satisfies (17b) and thus (17b) can be ignored. Thus, an optimizer of (17) can be written as

xᵤ←[u∈Nₗ][c_{fu}<πᵤ⁺]

Herein, the optimizer is valid for all u∈N, and [ ] is the binary indicator function.

In other embodiments, a different column projection method (which includes the above method as a subset) can be employed. This approach circumvents the combinatorial difficulty of the knapsack by considering a large subset of the columns respecting the solution to the knapsack described by l. This uses the size information contained in l but not the specific item information. Ω_{\hat{l}} can be defined such that a dynamic program can be used to solve for (10b), and includes first sort the item Nin size from largest to smallest, and then iterating over these items holding onto the lowest reduced cost partial column containing at most z items.

2.5 Example Techniques for Accelerating FCG

In some embodiments, FCG can be accelerated by not solving the FRMP exactly in the pseudocode shown in FIG. 3 (Algorithm 4) when to do so would require a large number of iterations, e.g., the loop solving the FRMP (lines 2-14 in Algorithm 4) are only run up to a finite number of iterations. In an example, the finite number of iterations can be a user-defined parameter. If Lines 2-14 do not terminate in that period via Line 8 (in Algorithm 3) we do not terminate optimization if no negative reduced cost column is found in Line 13, but instead continue with Algorithm 3. This procedure generates a column when only partially completed optimization over the FRMP is available, and FRMP optimization continues unmodified if no column with negative reduced cost is identified.

### 3 Analysis of Example Embodiments of FCG

The efficacy of the described embodiments in accelerating CG (when compared to baseline methods) is demonstrated through numerical simulations. In an example, FRMP is applied to SSCFLP, and its convergence time and iterations are evaluated when solving the linear relaxation. This performance is compared against unstabilized CG and against smoothing, which has shown to offer significant speedups on the SSCFLP.

The numerical simulations were performed on 50 randomly generated instances, each of which had 50 facilities and 250 customers. Each facility has a capacity of 150 and a fixed opening cost of 5. Each customer has a demand which is randomly generated uniformly over the set {1, 2, 3, 4, 5}. To generate random customer service costs, each customer along with each facility is randomly given a position uniformly on the unit square. Service cost for each facility to each customer are set as the distance from that facility's position to that particular customer.

Runtime and iteration count results for FRMP and smoothing are shown in Table 1.

TABLE 1
SSCFLP Results

| | Unstabilized | Smoothing | Family |
|---|---|---|---|
| mean total iterations | 1736.2 | 465.3 | 175.3 |
| median total iterations | 1212.5 | 373.5 | 148.5 |
| mean total runtime | 2750.0 | 79.7 | 125.1 |
| median total runtime | 521.7 | 67.9 | 78.6 |
| mean total LP runtime | 2735.6 | 76.5 | 10.0 |
| median total LP runtime | 513.3 | 65.3 | 24.0 |

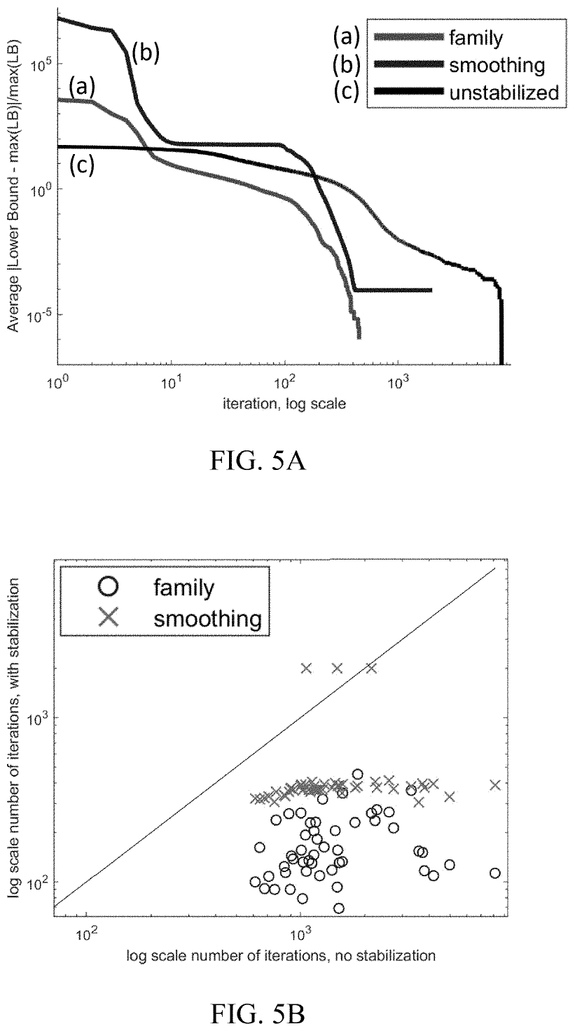

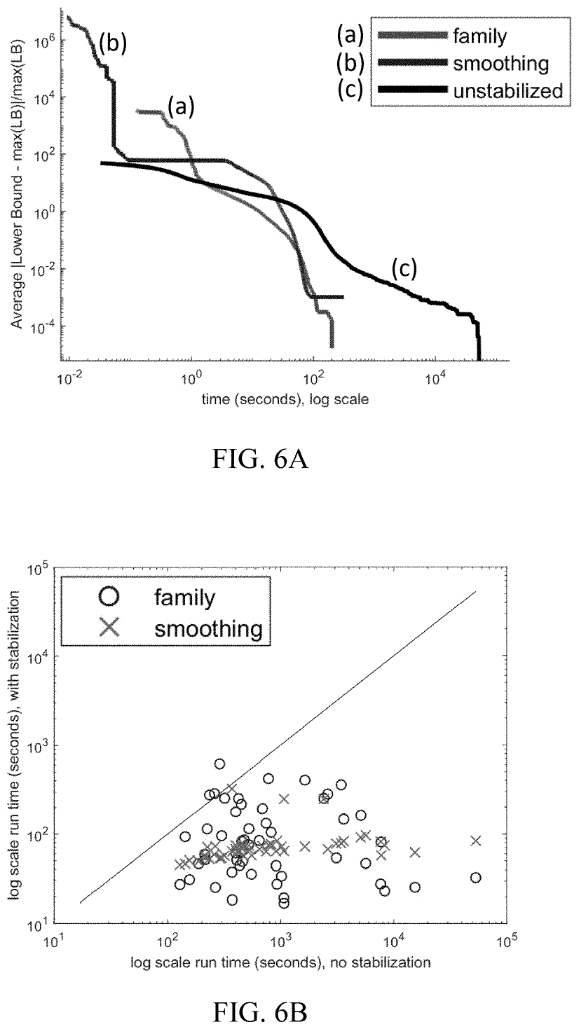

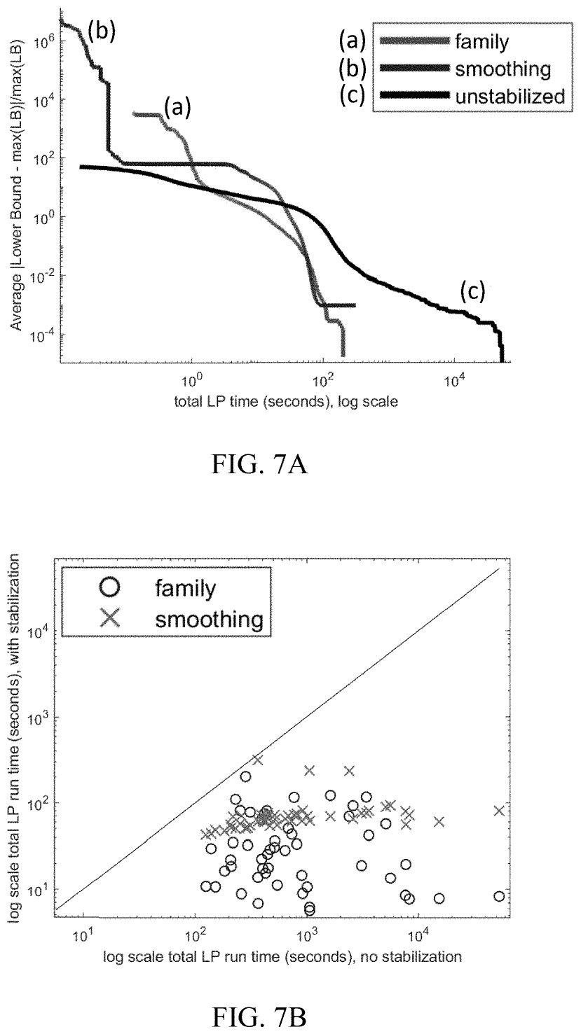

The FRMP shows significant reductions in the average number of iterations required (and consequently the number of calls to pricing) when compared to smoothing. Relevant plots for iteration counts are shown in FIGS. 5A and 5B. When considering total runtime, the FRMP falls short of outperforming smoothing on average. Plots for total runtime are shown in FIGS. 6A and 6B. Looking only at total LP solver time, the FRMP again offers vast improvements over smoothing. Relevant plots for LP runtime are shown in FIGS. 7A and 7B. In these plots, FIGS. 5A, 6A and 7A show the average relative gap for the lower bound as a function of iteration, total runtime, and total LP time, respectively. Family RMP and smoothing are compared over 50 instances for the iteration count, total runtime, and total LP time in FIGS. 5B, 6B and 7B, respectively.

### 4 Example Implementations of the Disclosed Technology

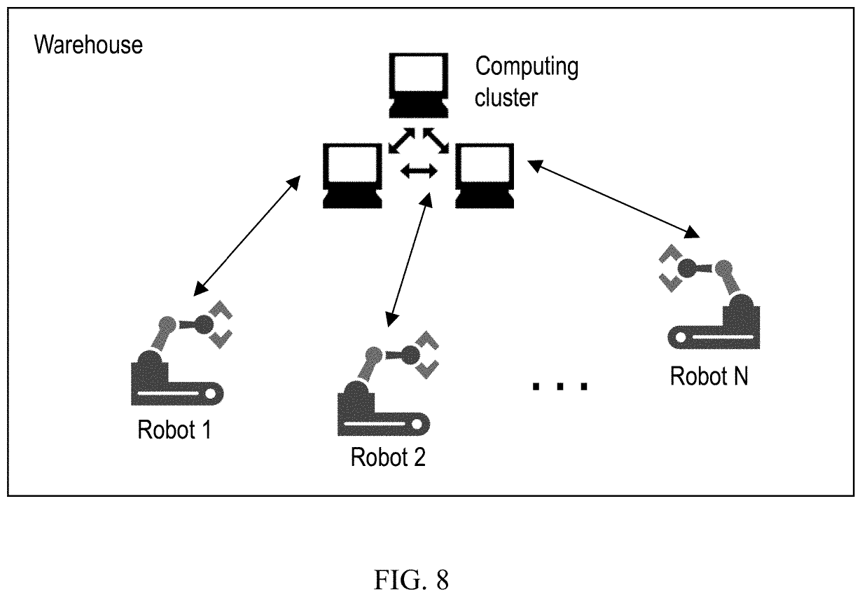

In some embodiments, the FCG methods described in this document can be applied, for example, to the framework shown in FIG. 8, which shows an example of the capacitated vehicle routing problem (CVRP) discussed in this document. As shown therein, a set of robots (or vehicles) as associated with a starting/ending depot, and are configured to service a set of customers with locations and demands. The computing cluster assigns the robots to routes such that all customers are serviced and the capacity of each robot is respected. In an example, each of the robots may have the same capacity. In another example, one or more of the robots may have a different capacity from the other robots.

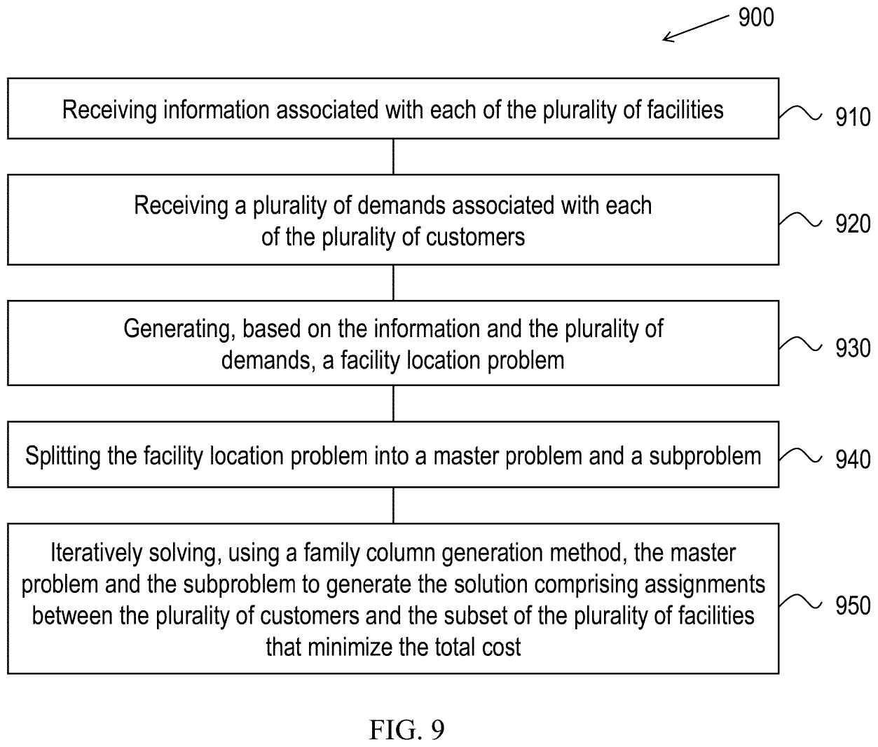

FIG. 9 is a flowchart of an example method 900 (e.g., as described in section 1.3) in accordance with the described embodiments. The method 900 includes, at operation 910, receiving information associated with each of the plurality of facilities, wherein the information comprises an opening cost and a capacity for the corresponding facility.

The method 900 includes, at operation 920, receiving a plurality of demands associated with each of the plurality of customers.

The method 900 includes, at operation 930, generating, based on the information and the plurality of demands, a facility location problem, wherein a solution to the facility location problem minimizes a total cost of opening a subset of the plurality of facilities such that (a) each of plurality of customers is assigned to exactly one of the subset of the plurality of facilities and (b) the demand for a particular customer is less than the capacity of the assigned facility, and wherein the total cost comprises the opening cost for each of subset of the plurality of facilities and a cost associated with assigning the particular customer to the corresponding facility.

The method 900 includes, at operation 940, splitting the facility location problem into a master problem and a subproblem, wherein the master problem and the subproblem comprise constraints associated with the facility location problem.

The method 900 includes, at operation 950, iteratively solving, using a family column generation method, the master problem and the subproblem to generate the solution comprising assignments between the plurality of customers and the subset of the plurality of facilities that minimize the total cost.

In some embodiments, the family column generation method comprises a column generation method, the column generation method comprises adding a column to the master problem as part of solving the subproblem, wherein the column corresponds to an assignment of a candidate customer to a candidate facility, the family column generation method further comprises adding a family of the column to the master problem as part of solving the subproblem, and the family of the column corresponds to assignments of additional candidate customers to the candidate facility such that a demand of each of the additional candidate customers is less than the capacity of the candidate facility.

In some embodiments, the method 900 is further described in section 2, which describes the algorithms for FCG (with the pseudocode shown in FIGS. 2-4). In an example, the column projection methods described in section 2.4 can be incorporated into method 900. In another example, the FCG can be accelerated using the methods described in section 2.5.

In some embodiments, the family column generation method is configured to support early termination, and wherein the early termination is based on a Lagrangian bound (e.g., as described in section 1.2), the Lagrangian bound is a value of a Lagrangian function evaluated at a given dual solution, and the Lagrangian function is a smooth, concave function with a value identical to the master problem at an optimizing dual solution for the master problem.

In some embodiments, the master problem is solved using a dual coordinate ascent method that comprises generating a direction of travel and a determining an optimal travel distance such that the master problem is optimally solved, and the determining the optimal travel distance is based on an approximation to a dual solution for the master problem.

In some embodiments, the facility location problem comprises a single source capacitated facility location problem, and the subproblem is an integer linear program that is solved using a 0-1 knapsack problem solver.

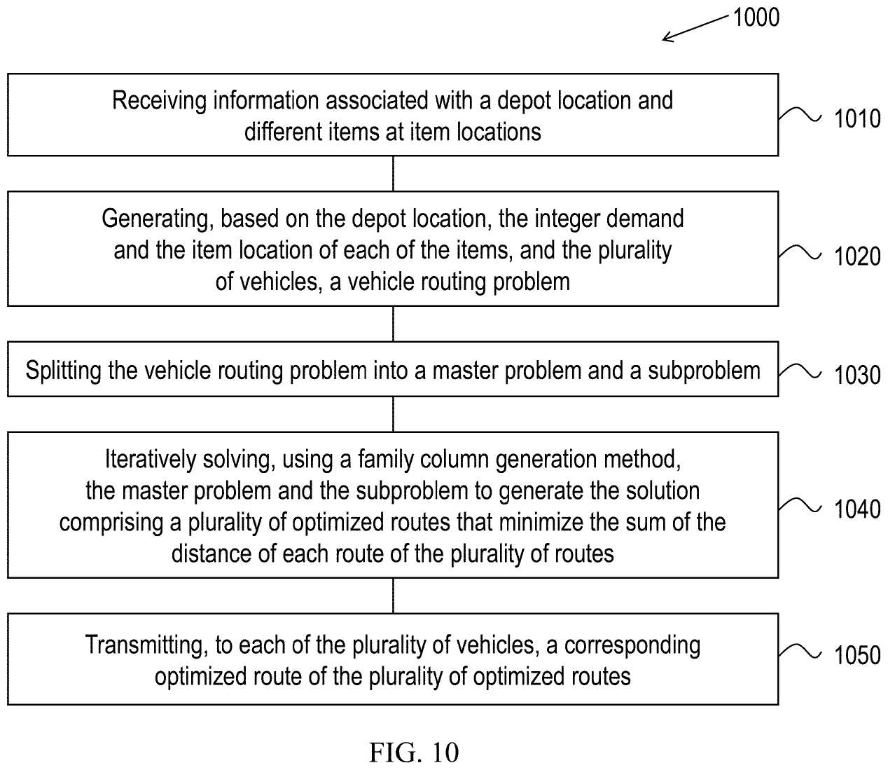

FIG. 10 is a flowchart of another example method 1000 in accordance with the described embodiments. The method 1000 includes, at operation 1010, receiving information associated with a depot location and different items at item locations, the information for each of the items comprising an item location and an integer demand indicating a size of the item.

The method 1000 includes, at operation 1020, generating, based on the depot location, the integer demand and the item location of each of the items, and the plurality of vehicles, a vehicle routing problem, wherein a solution to the vehicle routing problem minimizes a sum of a distance of each route of a plurality of routes, wherein each route of a plurality of routes for each of the plurality of vehicles (a) starts and ends at the depot location, (b) visits an item location no more than once, and (c) services a capacity that does not exceed each vehicle's capacity to carry items.

The method 1000 includes, at operation 1030, splitting the vehicle routing problem into a master problem and a subproblem, wherein the master problem and the subproblem comprise constraints associated with the vehicle routing problem.

The method 1000 includes, at operation 1040, iteratively solving, using a family column generation method, the master problem and the subproblem to generate the solution comprising a plurality of optimized routes that minimize the sum of the distance of each route of the plurality of routes.

The method 1000 includes, at operation 1050, transmitting, to each of the plurality of vehicles, a corresponding optimized route of the plurality of optimized routes.

In some embodiments, the family column generation method comprises a column generation method, the column generation method comprises adding a column to the master problem as part of solving the subproblem, wherein the column corresponds to a particular route with an ordering of items serviced by a particular vehicle on the particular route, the family column generation method further comprises adding a family of the column to the master problem as part of solving the subproblem, and the family of the column corresponds to one or more routes that maintain the ordering of the items with one or more items removed from each column in the family of the column.

In some embodiments, the master problem is a linear programming problem and the subproblem is a pricing problem.

In some embodiments, the pricing problem is an integer linear program that is solved using a shortest path solver.

In some embodiments, the family column generation method is configured to support early termination, and the early termination is based on a Lagrangian bound (e.g., as described in section 1.2).

Embodiments of the disclosed technology include a system comprising at least one memory, and at least one processor that is coupled to the at least one memory, wherein the at least one processor is configured to determine an assignment between a plurality of facilities and a plurality of customers, wherein the at least one processor is further configured to receive information associated with each of the plurality of facilities, wherein the information comprises an opening cost and a capacity for the corresponding facility, receive a plurality of demands associated with each of the plurality of customers, generate, based on the information and the plurality of demands, a facility location problem, wherein a solution to the facility location problem minimizes a total cost of opening a subset of the plurality of facilities such that (a) each of plurality of customers is assigned to exactly one of the subset of the plurality of facilities and (b) the demand for a particular customer is less than the capacity of the assigned facility, and wherein the total cost comprises the opening cost for each of subset of the plurality of facilities and a cost associated with assigning the particular customer to the corresponding facility, split the facility location problem into a master problem and a subproblem, wherein the master problem and the subproblem comprise constraints associated with the facility location problem, and iteratively solve, using a family column generation method, the master problem and the subproblem to generate the solution comprising assignments between the plurality of customers and the subset of the plurality of facilities that minimize the total cost, wherein the family column generation method comprises a column generation method, wherein the column generation method comprises adding a column to the master problem as part of solving the subproblem, wherein the column corresponds to an assignment of a candidate customer to a candidate facility, wherein the family column generation method further comprises adding a family of the column to the master problem as part of solving the subproblem, and wherein the family of the column corresponds to assignments of additional candidate customers to the candidate facility such that a demand of each of the additional candidate customers is less than the capacity of the candidate facility.

Embodiments of the disclosed technology further include a system comprising at least one memory, and at least one processor that is coupled to the at least one memory, wherein the at least one processor is configured to determine a route for a plurality of vehicles from a depot location to different items at item locations, wherein the at least one processor is further configured to receive information associated with the depot location and the items, wherein the information for each of the items comprises an item location and an integer demand indicating a size of the item, generate, based on the depot location, the integer demand and the item location of each of the items, and the plurality of vehicles, a vehicle routing problem, wherein a solution to the vehicle routing problem minimizes a sum of a distance of each route of a plurality of routes, wherein each route of a plurality of routes for each of the plurality of vehicles (a) starts and ends at the depot location, (b) visits an item location no more than once, and (c) services a capacity that does not exceed each vehicle's capacity to carry items, split the vehicle routing problem into a master problem and a subproblem, wherein the master problem and the subproblem comprise constraints associated with the vehicle routing problem, iteratively solve, using a family column generation method, the master problem and the subproblem to generate the solution comprising a plurality of optimized routes that minimize the sum of the distance of each route of the plurality of routes, and transmit, to each of the plurality of vehicles, a corresponding optimized route of the plurality of optimized routes, and wherein the family column generation method comprises a column generation method, wherein the column generation method comprises adding a column to the master problem as part of solving the subproblem, wherein the column corresponds to a particular route with an ordering of items serviced by a particular vehicle on the particular route, wherein the family column generation method further comprises adding a family of the column to the master problem as part of solving the subproblem, and wherein the family of the column corresponds to one or more routes that maintain the ordering of the items with one or more items removed from each column in the family of the column.

In these embodiments, the at least one processor comprises a first processor that is used to solve the master problem and a second processor that is used to solve the subproblem.

In these embodiments, the at least one processor is part of a cloud computing infrastructure.

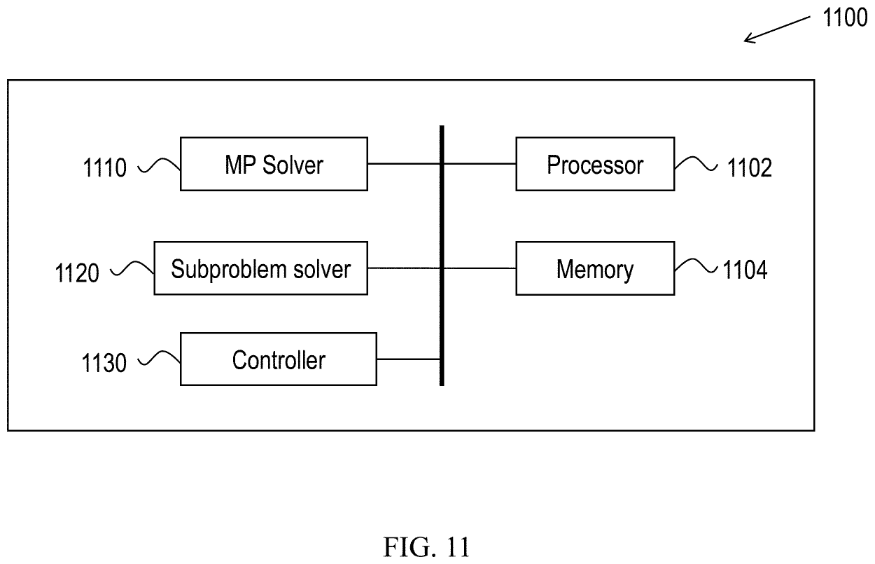

FIG. 11 shows an example of a hardware platform 1100 that can be used to implement some of the techniques described in the present document. The hardware platform 1100 may include a processor 1102 that can execute code to implement a method described in this document (e.g., methods 900 and 1000 shown in FIGS. 9 and 10, respectively). The hardware platform 1100 may include a memory 1104 that may be used to store processor-executable code and/or store data. The hardware platform 1100 may further include a controller 1130. For example, the controller 1130 may implement one or more scheduling or routing algorithms described in this document. The hardware platform may further include a master problem (MP) solver 1110 and a subproblem solver 1120, which are configured to implement the column generation methods described in this document. In some embodiments, some portion or all of the MP solver 1110, the subproblem solver 1120, and/or the controller 1130 may be implemented in the processor 1102. In other embodiments, the memory 1104 may comprise multiple memories, some of which are exclusively used by the 1\4P solver, the subproblem solver, and/or the controller.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A system comprising:
at least one memory; and
at least one processor that is coupled to the at least one memory,
wherein the at least one processor is configured to determine an assignment between a plurality of facilities and a plurality of customers,
wherein the at least one processor is further configured to:
receive information associated with each of the plurality of facilities, wherein the information comprises an opening cost and a capacity for the corresponding facility,
receive a plurality of demands associated with each of the plurality of customers,
generate, based on the information and the plurality of demands, a facility location problem, wherein a solution to the facility location problem minimizes a total cost of opening a subset of the plurality of facilities such that (a) each of plurality of customers is assigned to exactly one of the subset of the plurality of facilities and (b) the demand for a particular customer is less than the capacity of the assigned facility, and wherein the total cost comprises the opening cost for each of subset of the plurality of facilities and a cost associated with assigning the particular customer to the corresponding facility,
split the facility location problem into a master problem and a subproblem, wherein the master problem and the subproblem comprise constraints associated with the facility location problem, and
iteratively solve, using a family column generation method, the master problem and the subproblem to generate the solution comprising assignments between the plurality of customers and the subset of the plurality of facilities that minimize the total cost,
wherein the family column generation method comprises a column generation method,
wherein the column generation method comprises adding a column to the master problem as part of solving the subproblem, wherein the column corresponds to an assignment of a candidate customer to a candidate facility,
wherein the family column generation method further comprises adding a family of the column to the master problem as part of solving the subproblem, and wherein the family of the column corresponds to assignments of additional candidate customers to the candidate facility such that a demand of each of the additional candidate customers is less than the capacity of the candidate facility.

2. The system of claim 1, wherein the master problem is solved using a dual coordinate ascent method.

3. The system of claim 2, wherein the dual coordinate ascent method comprises generating a direction of travel and a determining an optimal travel distance such that the master problem is optimally solved.

4. The system of claim 3, wherein the determining the optimal travel distance is based on an approximation to a dual solution for the master problem.

5. The system of claim 1, wherein the family column generation method is configured to support early termination.

6. The system of claim 1, wherein the at least one processor comprises a first processor that is used to solve the master problem and a second processor that is used to solve the subproblem.

7. The system of claim 1, wherein the facility location problem comprises a single source capacitated facility location problem.

8. The system of claim 7, wherein the subproblem is an integer linear program that is solved using a 0-1 knapsack problem solver.

9. A system comprising:
at least one memory; and
at least one processor that is coupled to the at least one memory,
wherein the at least one processor is configured to determine a route for a plurality of vehicles from a depot location to different items at item locations,
wherein the at least one processor is further configured to:
receive information associated with the depot location and the items, wherein the information for each of the items comprises an item location and an integer demand indicating a size of the item,
generate, based on the depot location, the integer demand and the item location of each of the items, and the plurality of vehicles, a vehicle routing problem, wherein a solution to the vehicle routing problem minimizes a sum of a distance of each route of a plurality of routes, wherein each route of a plurality of routes for each of the plurality of vehicles (a) starts and ends at the depot location, (b) visits an item location no more than once, and (c) services a capacity that does not exceed each vehicle's capacity to carry items,
split the vehicle routing problem into a master problem and a subproblem, wherein the master problem and the subproblem comprise constraints associated with the vehicle routing problem,
iteratively solve, using a family column generation method, the master problem and the subproblem to generate the solution comprising a plurality of optimized routes that minimize the sum of the distance of each route of the plurality of routes, and
transmit, to each of the plurality of vehicles, a corresponding optimized route of the plurality of optimized routes, and
wherein the family column generation method comprises a column generation method,
wherein the column generation method comprises adding a column to the master problem as part of solving the subproblem, wherein the column corresponds to a particular route with an ordering of items serviced by a particular vehicle on the particular route,
wherein the family column generation method further comprises adding a family of the column to the master problem as part of solving the subproblem, and wherein the family of the column corresponds to one or more routes that maintain the ordering of the items with one or more items removed from each column in the family of the column.

10. The system of claim 9, wherein the master problem is a linear programming problem and the subproblem is a pricing problem.

11. The system of claim 10, wherein the pricing problem is an integer linear program that is solved using a shortest path solver.

12. The system of claim 9, wherein the family column generation method is configured to support early termination, and wherein the early termination is based on a Lagrangian bound.

13. The system of claim 9, wherein the at least one processor is part of a cloud computing infrastructure.

14. The system of claim 9, wherein the at least one processor comprises a first processor that is used to solve the master problem and a second processor that is used to solve the subproblem.

15. A method comprising:
receiving information associated with each of the plurality of facilities, wherein the information comprises an opening cost and a capacity for the corresponding facility;
receiving a plurality of demands associated with each of the plurality of customers;
generating, based on the information and the plurality of demands, a facility location problem, wherein a solution to the facility location problem minimizes a total cost of opening a subset of the plurality of facilities such that (a) each of plurality of customers is assigned to exactly one of the subset of the plurality of facilities and (b) the demand for a particular customer is less than the capacity of the assigned facility, and wherein the total cost comprises the opening cost for each of subset of the plurality of facilities and a cost associated with assigning the particular customer to the corresponding facility;
splitting the facility location problem into a master problem and a subproblem, wherein the master problem and the subproblem comprise constraints associated with the facility location problem; and
iteratively solving, using a family column generation method, the master problem and the subproblem to generate the solution comprising assignments between the plurality of customers and the subset of the plurality of facilities that minimize the total cost,
wherein the family column generation method comprises a column generation method,
wherein the column generation method comprises adding a column to the master problem as part of solving the subproblem, wherein the column corresponds to an assignment of a candidate customer to a candidate facility,
wherein the family column generation method further comprises adding a family of the column to the master problem as part of solving the subproblem, and wherein the family of the column corresponds to assignments of additional candidate customers to the candidate facility such that a demand of each of the additional candidate customers is less than the capacity of the candidate facility.

16. The method of claim 15, wherein the family column generation method is configured to support early termination, and wherein the early termination is based on a Lagrangian bound.

17. The method of claim 16, wherein the Lagrangian bound is a value of a Lagrangian function evaluated at a given dual solution, and wherein the Lagrangian function is a smooth, concave function with a value identical to the master problem at an optimizing dual solution for the master problem.

18. The method of claim 15, wherein the master problem is solved using a dual coordinate ascent method that comprises generating a direction of travel and a determining an optimal travel distance such that the master problem is optimally solved.

19. The method of claim 18, wherein the determining the optimal travel distance is based on an approximation to a dual solution for the master problem.

20. A method comprising:
receiving information associated with a depot location and different items at item locations, wherein the information for each of the items comprises an item location and an integer demand indicating a size of the item;
generating, based on the depot location, the integer demand and the item location of each of the items, and the plurality of vehicles, a vehicle routing problem, wherein a solution to the vehicle routing problem minimizes a sum of a distance of each route of a plurality of routes, wherein each route of a plurality of routes for each of the plurality of vehicles (a) starts and ends at the depot location, (b) visits an item location no more than once, and (c) services a capacity that does not exceed each vehicle's capacity to carry items;
splitting the vehicle routing problem into a master problem and a subproblem, wherein the master problem and the subproblem comprise constraints associated with the vehicle routing problem;
iteratively solving, using a family column generation method, the master problem and the subproblem to generate the solution comprising a plurality of optimized routes that minimize the sum of the distance of each route of the plurality of routes; and
transmitting, to each of the plurality of vehicles, a corresponding optimized route of the plurality of optimized routes,
wherein the family column generation method comprises a column generation method,
wherein the column generation method comprises adding a column to the master problem as part of solving the subproblem, wherein the column corresponds to a particular route with an ordering of items serviced by a particular vehicle on the particular route,
wherein the family column generation method further comprises adding a family of the column to the master problem as part of solving the subproblem, and wherein the family of the column corresponds to one or more routes that maintain the ordering of the items with one or more items removed from each column in the family of the column.
